(19) United States
(12) Patent Application Publication
(10) Pub. No.: US 2016/0109319 A1
(43) Pub. Date: Apr. 21, 2016

(54) METHOD AND APPARATUS OF MOMENT CALIBRATION FOR RESONANCE FATIGUE TEST

(71) Applicant: KOREA INSTITUTE OF MACHINERY & MATERIALS, Daejeon (KR)

(72) Inventors: Hakgu LEE, Changwon-si (KR); Byungsun HWANG, Jeonju-si (KR); Jinbum MOON, Changwon-si (KR); Wookyoung LEE, Gimhae-si (KR)

(21) Appl. No.: 14/885,644

(22) Filed: Oct. 16, 2015

Related U.S. Application Data
(60) Provisional application No. 62/065,435, filed on Oct. 17, 2014.

(51) Int. Cl. G01L 25/00

(52) U.S. Cl. CPC G01L 25/00

(57) ABSTRACT

A moment calibration method and apparatus are provided for a resonance fatigue test of a test article. In the moment calibration method, when a load applying unit of the apparatus applies a static load to the test article in a first direction so as to cause bending of the test article, a processor of the apparatus obtains a first measured value from a physical quantity measured by at least one measurement sensor attached to the test article. Also, when the load applying unit applies a static load to the test article in a second direction different from the first direction so as to cause bending of the test article, the processor obtains a second measured value from a physical quantity measured by the measurement sensor. Then the processor calculates a correlation between the first measured value, the second measured value, and moment values respectively calculated from the static loads applied in the first and second directions. By considering a dual-axis load state, the moment calibration method can obtain reliable calibration results exactly matching with a real fatigue test.

### TECHNICAL FIELD

The present invention relates to a fatigue test for a test article such as a wind turbine blade.

### BACKGROUND

A wind turbine blade is a distinguishing component of a wind power generator, and it would not be wrong to say the performance and lifetime of the entire system depend on the performance of a blade. A recent several-MW blade which is about several tens of meters long and weighs more than ten tons should be designed considering various load conditions and verified through a test. There are a static test and a fatigue test as tests for reliability verification of a blade.

Normally a fatigue test for a wind turbine blade is performed using a fatigue test apparatus 100 as shown in FIG. 1. Referring to FIG. 1, a blade 110 is fixed at a root to a test stand 120, thus forming a cantilever beam. An exciter 130 is mounted on the blade 110 and applies a repeated force to the blade 110 so as to induce oscillation of a cantilever beam.

An excitation force is adjusted so that a bending moment distribution caused by oscillation of the blade 110 can exceed a target bending moment distribution. Using resonance, the blade 110 vibrates at a certain amplitude in a target cycle. Typically such a target cycle is set to several million cycles. For example, a full-scale fatigue test needs a flapwise test with 1 million cycles and an edgewise test with 2 million cycles, spending a very long test time of about three months.

Fatigue testing methods are classified into two categories, i.e., forced-displacement type fatigue testing and resonance type fatigue testing. Between both, the latter type has recently attracted attention in view of providing a greater oscillating range required. Namely, a resonance fatigue test can be efficiently conducted at the natural frequency exploiting resonance. Since allowing the blade to oscillate at a great amplitude even by a smaller actuating force, a resonance fatigue test can considerably reduce energy required for a fatigue test.

Additionally, a fatigue test includes a flapwise test for actuating the blade in a flapwise direction and an edgewise test for actuating the blade in an edgewise direction. A single-axis test is to perform separately both tests, and a dual-axis test is to perform simultaneously both tests.

Meanwhile, before a fatigue test, strain gauges are attached on the blade, and then a static load is applied to the blade. Strain is measured through the strain gauges, and also a moment is calculated therefrom. This is referred to as calibration.

According to a typical calibration method, after a static load is applied to the blade, a correlation between a resultant bending moment and a measurement signal of the strain gauges is calculated. Particularly, calibration for a flapwise fatigue test is performed using only a static load in a flapwise direction, and similarly calibration for an edgewise fatigue test is performed using only a static load in an edgewise direction. Unfortunately, such a typical calibration method basically has a dynamical problem, as follows.

In a calibration situation, the component applied to the blade is merely a single-axis load component because a static load is used. However, a real fatigue test is in a dynamical load state, and thereby the blade moves in a diagonal direction, being nonparallel to an actuating direction, even in case of a single-axis test as well as a dual-axis test. This may be referred to as nonsymmetrical bending. A diagonal motion of the blade causes an inertia force having both vertical and horizontal components, and thereby dual-axis load components exist.

Therefore, even though a fatigue test is performed using strain and moment measured and calculated by a conventional calibration method, a real test may often fail to match with calibration results. The reason is that moment calculated in view of one direction only is applied to a real test performed under nonsymmetrical bending.

### SUMMARY

Accordingly, in order to address the aforesaid or any other issue, the present invention provides new moment calibration technique. In particular, this technique of the invention is a new approach considering a dual-axis load state of a real fatigue test in comparison with a conventional approach in view of a single-axis load state.

Various embodiments of the present invention provide a moment calibration method for a resonance fatigue test of a test article. This method may include steps of: (a) applying a static load to the test article in a first direction so as to cause bending of the test article; (b) obtaining a first measured value from a physical quantity measured by at least one measurement sensor attached to the test article; (c) applying a static load to the test article in a second direction so as to cause bending of the test article, the second direction being different from the first direction; (d) obtaining a second measured value from a physical quantity measured by the at least one measurement sensor attached to the test article; and (e) calculating a correlation between the first measured value, the second measured value, and moment values respectively calculated from the static loads applied in the first and second directions.

In the method, the at least one measurement sensor may include measurement sensors disposed at different positions on the same cross-section of the test article.

In this case, the measurement sensors may include at least one first measurement sensor disposed on the test article in the first direction, and at least one second measurement sensor disposed on the test article in the second direction.

Further, at the step (b), the first measurement sensor may measure a relatively greater physical quantity due to bending in the first direction caused by the applied static load in comparison with a physical quantity due to bending in the second direction caused by nonsymmetrical bending, and the second measurement sensor may measure a relatively greater physical quantity due to bending in the second direction caused by nonsymmetrical bending in comparison with a physical quantity due to bending in the first direction caused by the applied static load.

Additionally, at the step (d), the second measurement sensor may measure a relatively greater physical quantity due to bending in the second direction caused by the applied static load in comparison with a physical quantity due to bending in the first direction caused by nonsymmetrical bending, and the first measurement sensor may measure a relatively greater physical quantity due to bending in the first direction caused by nonsymmetrical bending in comparison with a physical quantity due to bending in the second direction caused by the applied static load.

In the method, the step (e) may be performed separately after the step (b) and after the step (d) or performed en bloc after the step (d).

Meanwhile, various embodiments of the present invention also provide a moment calibration apparatus for a resonance fatigue test of a test article. This apparatus may include a test stand configured to fix one end of the test article; at least one measurement sensor attached to the test article; a processor configured to process a signal received from the measurement sensor; and a load applying unit configured to apply a static load to the test article. In this apparatus, the processor may obtain a first measured value from a physical quantity measured by the measurement sensor when the load applying unit applies a static load to the test article in a first direction so as to cause bending of the test article. Also, the processor may obtain a second measured value from a physical quantity measured by the measurement sensors when the load applying unit applies a static load to the test article in a second direction so as to cause bending of the test article, the second direction being different from the first direction. And also, the processor may calculate a correlation between the first measured value, the second measured value, and moment values respectively calculated from the static loads applied in the first and second directions.

In the apparatus, the at least one measurement sensor may include measurement sensors disposed at different positions on the same cross-section of the test article.

In this case, the measurement sensors may include at least one first measurement sensor disposed on the test article in the first direction, and at least one second measurement sensor disposed on the test article in the second direction.

When the static load is applied in the first direction, the first measurement sensor may measure a relatively greater physical quantity due to bending in the first direction caused by the applied static load in comparison with a physical quantity due to bending in the second direction caused by nonsymmetrical bending. When the static load is applied in the second direction, the first measurement sensor may measure a relatively greater physical quantity due to bending in the first direction caused by nonsymmetrical bending in comparison with a physical quantity due to bending in the second direction caused by the applied static load, and

When the static load is applied in the first direction, the second measurement sensor may measure a relatively greater physical quantity due to bending in the second direction caused by nonsymmetrical bending in comparison with a physical quantity due to bending in the first direction caused by the applied static load. When the static load is applied in the second direction, the second measurement sensor may measure a relatively greater physical quantity due to bending in the second direction caused by the applied static load in comparison with a physical quantity due to bending in the first direction caused by nonsymmetrical bending.

In the above method and apparatus, the test article may be one of a wind turbine blade, a bridge, a building, a yacht mast, or any other structure which has a possibility of oscillation and needs a fatigue test. If the test article is a wind turbine blade, the first direction and the second direction may be flapwise direction and edgewise direction, respectively, of the wind turbine blade.

### BRIEF DESCRIPTION OF THE DRAWINGS

FIG. 1 is a schematic diagram illustrating a typical resonance fatigue test apparatus.

FIG. 2 is a schematic diagram illustrating a resonance fatigue test apparatus for performing moment calibration according to an embodiment of the present invention.

FIG. 3 is a diagram illustrating an ideal arrangement of strain gauges.

FIG. 4 is a diagram illustrating a real arrangement of strain gauges.

FIG. 5 is a flow diagram illustrating a moment calibration method for a resonance fatigue test according to an embodiment of the present invention.

FIG. 6 is an example diagram illustrating the result of calculating a linear ratio between a measured strain value and a bending moment value according to an embodiment of the present invention.

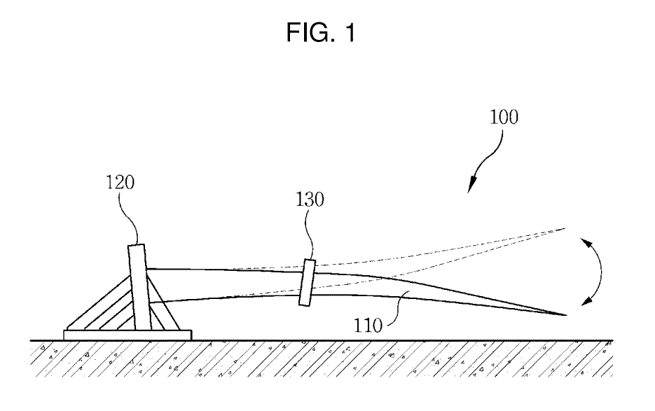

### DETAILED DESCRIPTION

Hereinafter, embodiments of the present invention will be described with reference to the accompanying drawings.

This invention may be embodied in many different forms and should not be construed as limited to the embodiments set forth herein. Rather, the disclosed embodiments are provided so that this invention will be thorough and complete, and will fully convey the scope of the invention to those skilled in the art. The principles and features of the present invention may be employed in varied and numerous embodiments without departing from the scope of the invention.

Furthermore, well known or widely used techniques, elements, structures, and processes may not be described or illustrated in detail to avoid obscuring the essence of the present invention. Although the drawings represent exemplary embodiments of the invention, the drawings are not necessarily to scale and certain features may be exaggerated or omitted in order to better illustrate and explain the present invention.

Through the drawings, the same or similar reference numerals denote corresponding features consistently.

Unless defined differently, all terms used herein, which include technical terminologies or scientific terminologies, have the same meaning as that understood by a person skilled in the art to which the present invention belongs. Singular forms are intended to include plural forms unless the context clearly indicates otherwise.

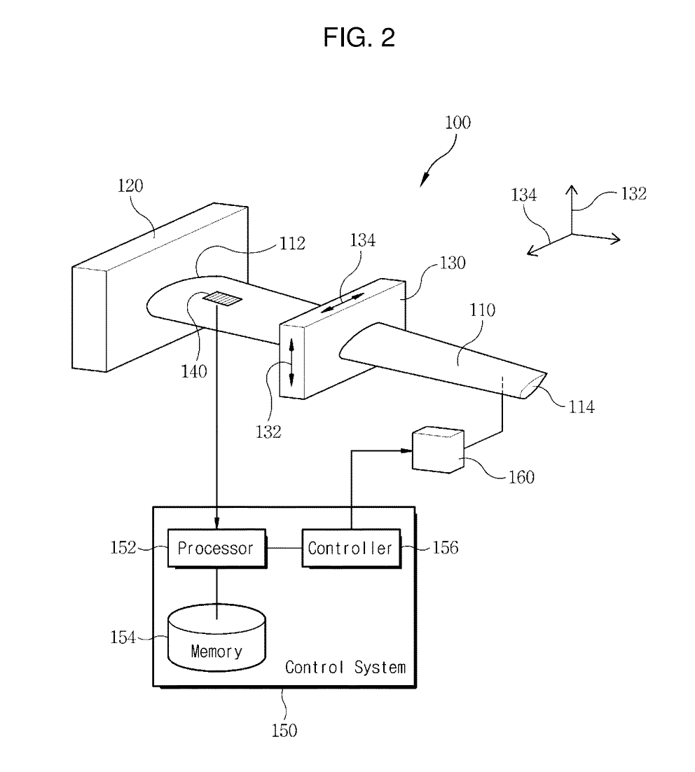

FIG. 2 is a schematic diagram illustrating a resonance fatigue test apparatus for performing moment calibration according to an embodiment of the present invention.

The resonance fatigue test apparatus 100 is an apparatus configured to perform a fatigue test for a test article such as a wind turbine blade 110. However, FIG. 2 illustrates a situation of moment calibration before a real resonance fatigue test is performed. Therefore, the apparatus 100 shown in FIG. 2 will be referred to as a moment calibration apparatus. Meanwhile, the test article is a wind turbine blade in this embodiment. This is, however, exemplary only and not to be considered as a limitation of the present invention. In other various embodiments, the test article may be a bridge, a building, a yacht mast, or any other structure which has a possibility of oscillation and needs a fatigue test.

The blade 110 is fixed to a test stand 120 at one end thereof, i.e., a root 112, thus forming a cantilever beam. The other end of the blade 110 is referred to as a tip 114. An exciter 130 is mounted on the blade 110. Even though the exciter 130 applies a repeated force to the blade 110 so as to induce oscillation during a real fatigue test, the exciter 130 merely performs the role of a mass only in a moment calibration situation of this invention. In FIG. 2, the exciter 130 is illustrated simply, and types or detailed structures thereof do not limit the invention.

A load applying unit 160 applies a static load to the blade 110, so that bending occurs at the blade 110. Specifically, the load applying unit 160 is connected to a certain point near the tip 114 of the blade 110 and applies a predetermined static load in a flapwise direction 132 of the blade 110 or in an edgewise direction 134 of the blade 110. A winch, a crane, or any other similar machine capable of pulling the blade 110 by means of a wire or the like may be used as the load applying unit 160. Further, the load applying unit 160 may use an additional member such as, but not limited to, an edge roller (not shown) so as to change a direction of applying a static force to the blade 110. Although FIG. 2 shows that the load applying unit 160 is connected to the lower face of the blade 110 through a wire in order to apply a downward static load in the flapwise direction 132, this is exemplary only. Alternatively, the load applying unit 160 may be connected to the upper face of the blade 110 in order to apply an upward static load in the flapwise direction 132. Also, in order to apply a static load in the edgewise direction 134, the load applying unit 160 may be connected to the lateral face of the blade 110 through a wire.

At least one strain gauge 140 is attached to the blade 110. Even though a single strain gauge is shown in FIG. 2 to avoid complexity, two or more strain gauges 140 may be used. In this case, the strain gauges 140 may be disposed at different positions on the same cross-section of the blade 110 (i.e., at the same distance from the blade root). Additionally, such dispositions of the strain gauges 140 may be distributed at several cross-sections along the longitudinal direction of the blade 110. The strain gauge 140 is an example of a measurement sensor and may be replaced with any other sensor such as an optical sensor in other embodiments. When the load applying unit 160 applies a static load to the blade 110 in a certain direction and thereby bending of the blade 110 occurs, the strain gauge 140 measures a physical quantity (e.g., strain) caused by bending of the blade 110 and then transmits such a measured value to a processor 152. The processor 152 stores the received value in a memory 154. If a measurement sensor is an optical sensor rather than the strain gauge 140, a physical quantity obtained by the optical sensor may be a wavelength variation. If there are a lot of strain gauges 140, a data acquisition device (not shown) may be used for collecting measured values from the strain gauges 140 and for transmitting the collected values to the processor 152.

A control system 150 for moment calibration includes the aforesaid processor 152, the aforesaid memory 154, and a controller 156.

The processor 152 obtains a measured value (e.g., strain) from a measurement sensor (e.g., the strain gauge 140). Also, the processor 152 calculates a bending moment value from a static load applied to the blade 110 by the load applying unit 160. And also, the processor 152 calculates a correlation (e.g., a linear ratio) between the obtained measured value and the calculated moment value. A detailed description regarding this will be made below.

The memory 154 stores conditions and parameters required for or associated with moment calibration. For example, the memory 154 stores a static load value applied to the blade 110 by the load applying unit 160, a bending moment value calculated using a static load value, a physical quantity or measured value received from a measurement sensor such as the strain gauge 140, a correlation between a measure value and a moment value calculated by the processor 152, and the like.

The controller 156 controls the load applying unit 160 to apply a static load to the blade 110, based on a predetermined value stored in the memory 154.

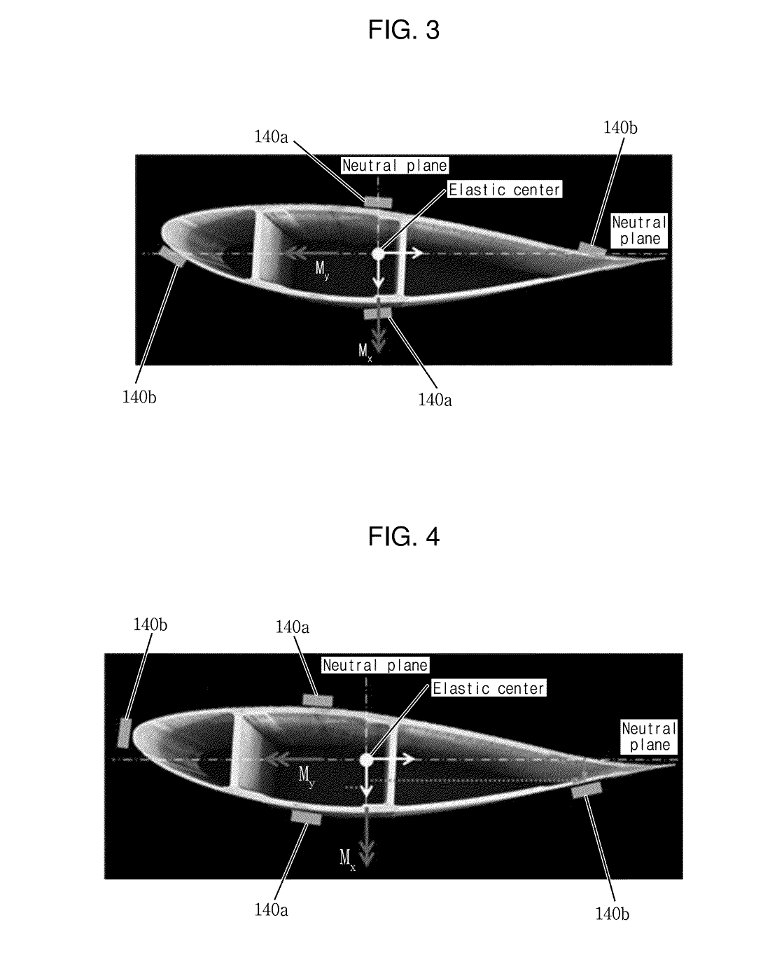

Meanwhile, ideally, the strain gauges 140a and 140b should be disposed on the neutral plane passing through the elastic center of the blade as shown in FIG. 3. However, the blade is designed in a nonsymmetrical form, and it is difficult to find the elastic center of the blade. Therefore, actually, the strain gauges 140a and 140b are disposed at arbitrary positions which are away from the neutral plane passing through the elastic center as shown in FIG. 4. In examples shown in FIGS. 3 and 4, a pair of strain gauges 140a may be referred to as flapwise strain gauges disposed in the flapwise direction of the blade, and another pair of strain gauges 140b may be referred to as edgewise strain gauges disposed in the edgewise direction of the blade.

Since the strain gauges 140a and 140b are disposed at positions out of the elastic center of the blade and since nonsymmetrical bending of the blade is caused in a real fatigue test as discussed above, moment calibration should consider a dual-axis load state in order to obtain reliable calibration results which exactly match with a real fatigue test.

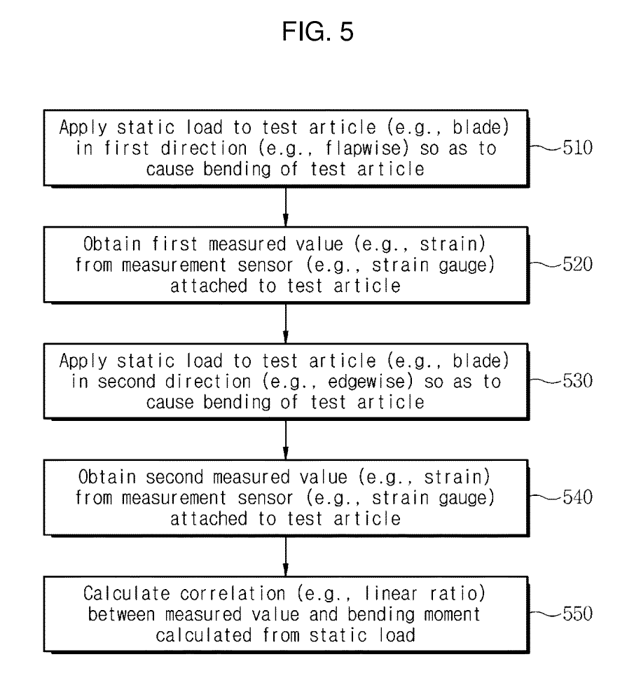

FIG. 5 is a flow diagram illustrating a moment calibration method for a resonance fatigue test according to an embodiment of the present invention. The moment calibration method shown in FIG. 5 may be performed using the load applying unit 160, the strain gauges 140, the processor 152, etc. as shown in FIG. 2. Also, the strain gauges 140a and 140b may be disposed as shown in FIG. 4.

Referring to FIG. 5, at step 510, the load applying unit 160 applies a predetermined static load in the first direction (e.g., flapwise) of the blade under the control of the controller 156. The applied static load causes bending of the blade.

At step 520, the processor 152 obtains the first measured value from strain measured by the strain gauges 140a and 140b. At this step, the first strain gauge (e.g., the flapwise strain gauge 140a) measures a relatively greater strain due to bending in the first direction caused by the applied static load in comparison with a strain due to bending in the second direction caused by nonsymmetrical bending. On the contrary, the second strain gauge (e.g., the edgewise strain gauge 140b) measures a relatively greater strain due to bending in the second direction caused by nonsymmetrical bending in comparison with a strain due to bending in the first direction caused by the applied static load.

At step 530, the load applying unit 160 applies a predetermined static load in the second direction (e.g., edgewise) of the blade under the control of the controller 156. The applied static load causes bending of the blade.

At step 540, the processor 152 obtains the second measured value from strain measured by the strain gauges 140a and 140b. At this step, the second strain gauge (e.g., the edgewise strain gauge 140b) measures a relatively greater strain due to bending in the second direction caused by the applied static load in comparison with a strain due to bending in the first direction caused by nonsymmetrical bending. On the contrary, the first strain gauge (e.g., the flapwise strain gauge 140a) measures a relatively greater strain due to bending in the first direction caused by nonsymmetrical bending in comparison with a strain due to bending in the second direction caused by the applied static load.

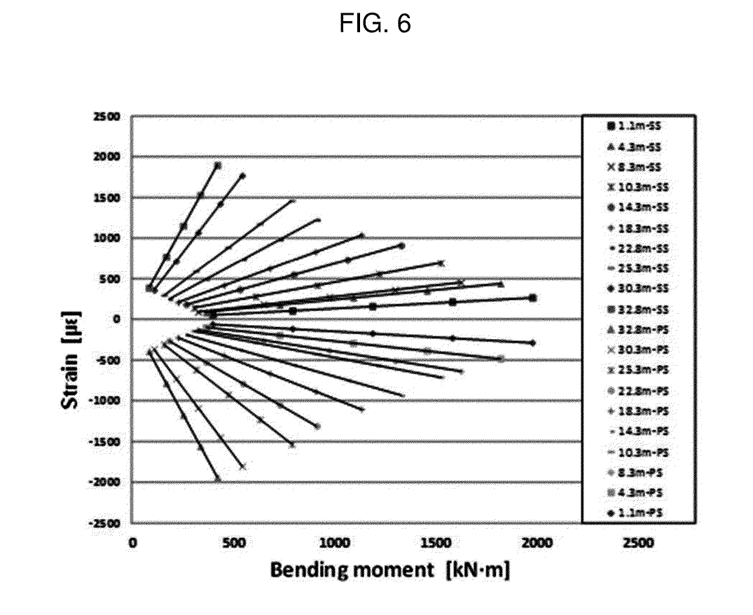

At step 550, the processor 152 calculates a correlation between the measured value and a moment value obtained from the applied static load. For example, the processor 152 calculates a linear ratio between the measured strain value and a bending moment value by considering the first bending moment calculated from the static load applied in the first direction at step 510, the first measured strain value obtained at step 520, the second bending moment calculated from the static load applied in the second direction at step 530, and the second measured strain value obtained at step 540. The calculated linear ratio is shown exemplarily in FIG. 6.

Step 550 may be performed separately after step 520 and after step 540. Alternatively, step 550 may be performed en bloc after step 540.

After a correlation between the measured value and the moment value is obtained according to the above-discussed moment calibration method, a test bending moment for a fatigue test can be calculated from the obtained correlation. Hereinafter, this will be described in detail.

When a distance between the neutral plane and the strain gauge with regard to flapwise bending is denoted by xᵢ, a distance between the neutral plane and the strain gauge with regard to edgewise bending is denoted by yᵢ, a curvature with regard to flapwise bending is denoted by ρ_{y}, and a curvature with regard to edgewise bending is denoted by ρₓ, a measured strain value ε_{zz} is expressed as Equation 1 given below.

$${ɛ}_{zz} = \frac{{y}_{i}}{{ρ}_{x}} + \frac{{x}_{i}}{{ρ}_{y}} \qquad [ Equation 1 ]$$

Additionally, when an edgewise moment is denoted by Mₓ and a flapwise moment is denoted by M_{y}, a curvature ρ_{y} with regard to flapwise bending and a curvature ρₓ with regard to edgewise bending are expressed as Equation 2 given below. In Equation 2, EIₓₓ denotes edgewise bending stiffness, EI_{yy} denotes flapwise bending stiffness, and EI_{xy} denotes edgewise bending stiffness associated with coupling. Meanwhile, moment can be calculated as the product of an applied load and a distance between the load and the strain gauge.

$$\{ \begin{matrix}\frac{1}{{ρ}_{x}} \\ \frac{1}{{ρ}_{y}}\end{matrix} \} = [ \begin{matrix}\frac{{EI}_{yy}}{{EI}_{xx} {EI}_{yy} - {( {EI}_{xy} )}^{2}} & \frac{- {EI}_{xy}}{{EI}_{xx} {EI}_{yy} - {( {EI}_{xy} )}^{2}} \\ \frac{- {EI}_{xy}}{{EI}_{xx} {EI}_{yy} - {( {EI}_{xy} )}^{2}} & \frac{{EI}_{xx}}{{EI}_{xx} {EI}_{yy} - {( {EI}_{xy} )}^{2}}\end{matrix} ] \{ \begin{matrix}{M}_{x} \\ {M}_{y}\end{matrix} \} \qquad [ Equation 2 ]$$

At step 520 discussed above, the first measured value can be calculated using Equation 2, as shown in Equation 3.

$$\{ \begin{matrix}\frac{1}{{ρ}_{x}} \\ \frac{1}{{ρ}_{y}}\end{matrix} \} = [ \begin{matrix}\frac{{EI}_{yy}}{{EI}_{xx} {EI}_{yy} - {( {EI}_{xy} )}^{2}} & \frac{- {EI}_{xy}}{{EI}_{xx} {EI}_{yy} - {( {EI}_{xy} )}^{2}} \\ \frac{- {EI}_{xy}}{{EI}_{xx} {EI}_{yy} - {( {EI}_{xy} )}^{2}} & \frac{{EI}_{xx}}{{EI}_{xx} {EI}_{yy} - {( {EI}_{xy} )}^{2}}\end{matrix} ] \{ \begin{matrix}{M}_{x} \\ 0\end{matrix} \} \qquad [ Equation 3 ]$$

When Equation 3 is substituted for Equation 1, Equation 4 is obtained.

$${ɛ}_{zz}^{( i )} = \frac{{y}_{i}}{{ρ}_{x}} + \frac{{x}_{i}}{{ρ}_{y}} = \frac{{EI}_{yy} {y}_{i} - {EI}_{xy} {x}_{i}}{{EI}_{xx} {EI}_{yy} - {( {EI}_{xy} )}^{2}} {M}_{x} \qquad [ Equation 4 ]$$

From Equation 4, a linear ratio eₑ⁽ⁱ⁾ between the edgewise moment and the measured strain value is obtained as Equation 5.

$${e}_{e}^{( i )} = \frac{{ɛ}_{zz}^{( i )}}{{M}_{x}} = \frac{{EI}_{yy} {y}_{i} - {EI}_{xy} {x}_{i}}{{EI}_{xx} {EI}_{yy} - {( {EI}_{xy} )}^{2}} \qquad [ Equation 5 ]$$

Meanwhile, when Mₓ is substituted for 0 in Equation 2 and then calculation like Equations 3 to 5 is performed, a linear ratio e_{f}⁽ⁱ⁾ between the flapwise moment and the measured strain value can be obtained.

From Equations 1 and 2, strain in dual-axis load state can be expressed as Equation 6.

$${ɛ}_{zz}^{( i )} = \frac{{y}_{i}}{{ρ}_{x}} + \frac{{x}_{i}}{{ρ}_{y}} = \frac{{EI}_{xx} {x}_{i} - {EI}_{xy} {y}_{i}}{{EI}_{xx} {EI}_{yy} - {( {EI}_{xy} )}^{2}} {M}_{y} + \frac{{EI}_{yy} {y}_{i} - {EI}_{xy} {x}_{i}}{{EI}_{xx} {EI}_{yy} - {( {EI}_{xy} )}^{2}} {M}_{x} = {e}_{f}^{( i )} {M}_{y} + {e}_{e}^{( i )} {M}_{x} \qquad [ Equation 6 ]$$

Therefore, if two strain values measured from different two strain gauges, a linear ratio e_{f}⁽ⁱ⁾ between a flapwise moment and a measured strain value, and a linear ratio eₑ⁽ⁱ⁾ between an edgewise moment and a measured strain value are known, it is possible to calculate flapwise bending moment M_{y} and edgewise bending moment Mₓ in a dual-axis load state.

As discussed hereinbefore, by considering a dual-axis load state, the moment calibration method according to this invention can obtain reliable calibration results exactly matching with a real fatigue test. The present invention can be efficiently applied to a single-axis resonance fatigue test as well as a dual-axis resonance fatigue test.

While the present invention has been particularly shown and described with reference to an exemplary embodiment thereof, it will be understood by those skilled in the art that various changes in form and details may be made therein without departing from the spirit and scope of the invention as defined by the appended claims.

What is claimed is:

1. A moment calibration method for a resonance fatigue test of a test article, the method comprising steps of:
(a) applying a static load to the test article in a first direction so as to cause bending of the test article;
(b) obtaining a first measured value from a physical quantity measured by at least one measurement sensor attached to the test article;
(c) applying a static load to the test article in a second direction so as to cause bending of the test article, the second direction being different from the first direction;
(d) obtaining a second measured value from a physical quantity measured by the at least one measurement sensor attached to the test article; and
(e) calculating a correlation between the first measured value, the second measured value, and moment values respectively calculated from the static loads applied in the first and second directions.

2. The method of claim 1, wherein the at least one measurement sensor includes measurement sensors disposed at different positions on the same cross-section of the test article.

3. The method of claim 2, wherein the measurement sensors includes:
at least one first measurement sensor disposed on the test article in the first direction; and
at least one second measurement sensor disposed on the test article in the second direction.

4. The method of claim 3, wherein, at the step (b), the first measurement sensor measures a relatively greater physical quantity due to bending in the first direction caused by the applied static load in comparison with a physical quantity due to bending in the second direction caused by nonsymmetrical bending, and the second measurement sensor measures a relatively greater physical quantity due to bending in the second direction caused by nonsymmetrical bending in comparison with a physical quantity due to bending in the first direction caused by the applied static load.

5. The method of claim 3, wherein, at the step (d), the second measurement sensor measures a relatively greater physical quantity due to bending in the second direction caused by the applied static load in comparison with a physical quantity due to bending in the first direction caused by nonsymmetrical bending, and the first measurement sensor measures a relatively greater physical quantity due to bending in the first direction caused by nonsymmetrical bending in comparison with a physical quantity due to bending in the second direction caused by the applied static load.

6. The method of claim 1, wherein the step (e) is performed separately after the step (b) and after the step (d).

7. The method of claim 1, wherein the step (e) is performed en bloc after the step (d).

8. The method of claim 1, wherein the test article is one of a wind turbine blade, a bridge, a building, a yacht mast, or any other structure which has a possibility of oscillation and needs a fatigue test.

9. The method of claim 1, wherein the test article is a wind turbine blade, and wherein the first direction and the second direction are flapwise direction and edgewise direction of the wind turbine blade, respectively.

10. A moment calibration apparatus for a resonance fatigue test of a test article, the apparatus comprising:
a test stand configured to fix one end of the test article;
at least one measurement sensor attached to the test article;
a processor configured to process a signal received from the measurement sensor; and
a load applying unit configured to apply a static load to the test article,
wherein the processor obtains a first measured value from a physical quantity measured by the measurement sensor when the load applying unit applies a static load to the test article in a first direction so as to cause bending of the test article,
wherein the processor obtains a second measured value from a physical quantity measured by the measurement sensor when the load applying unit applies a static load to the test article in a second direction so as to cause bending of the test article, the second direction being different from the first direction, and
wherein the processor calculates a correlation between the first measured value, the second measured value, and moment values respectively calculated from the static loads applied in the first and second directions.

11. The apparatus of claim 10, wherein the at least one measurement sensor includes measurement sensors disposed at different positions on the same cross-section of the test article.

12. The apparatus of claim 11, wherein the measurement sensors includes:
at least one first measurement sensor disposed on the test article in the first direction; and
at least one second measurement sensor disposed on the test article in the second direction.

13. The apparatus of claim 12, wherein when the static load is applied in the first direction, the first measurement sensor measures a relatively greater physical quantity due to bending in the first direction caused by the applied static load in comparison with a physical quantity due to bending in the second direction caused by nonsymmetrical bending, and when the static load is applied in the second direction, the first measurement sensor measures a relatively greater physical quantity due to bending in the first direction caused by nonsymmetrical bending in comparison with a physical quantity due to bending in the second direction caused by the applied static load, and
wherein when the static load is applied in the first direction, the second measurement sensor measures a relatively greater physical quantity due to bending in the second direction caused by nonsymmetrical bending in comparison with a physical quantity due to bending in the first direction caused by the applied static load, and when the static load is applied in the second direction, the second measurement sensor measures a relatively greater physical quantity due to bending in the second direction caused by the applied static load in comparison with a physical quantity due to bending in the first direction caused by nonsymmetrical bending.

14. The apparatus of claim 10, wherein the test article is one of a wind turbine blade, a bridge, a building, a yacht mast, or any other structure which has a possibility of oscillation and needs a fatigue test.

15. The apparatus of claim 10, wherein the test article is a wind turbine blade, and wherein the first direction and the second direction are flapwise direction and edgewise direction of the wind turbine blade, respectively.
